(19) United States
(12) Patent Application Publication
(10) Pub. No.: US 2016/0077959 A1
(43) Pub. Date: Mar. 17, 2016

(54) System and Method for Sharing a Solid-State Non-Volatile Memory Resource

(71) Applicant: Qualcomm Incorporated, San Diego, CA (US)

(72) Inventors: NHON TOAI QUACH, San Jose, CA (US); YANRU LI, San Diego, CA (US); WILLIAM EDWARD KIMBERLY, San Diego, CA (US)

(21) Appl. No.: 14/485,555

(22) Filed: Sep. 12, 2014

(51) Int. Cl. G06F 12/02

(52) U.S. Cl. CPC G06F 12/0246; G06F 12/0284

(57) ABSTRACT

A computing device and methods for exposing a solid-state non-volatile memory element to multiple masters in a computing device are disclosed. A portion of a solid-state non-volatile memory element includes code and data for use by a non-boot processing resource. A host controller in communication with the solid-state non-volatile memory element is modified to receive and respond to a resource identifier unique to the processing resource that is requesting read access to the solid-state non-volatile memory element. Logic executed by a boot master and logic executed by a non-boot processing resource are synchronized in response to a set of indicators.

### DESCRIPTION OF THE RELATED ART

Computing devices are ubiquitous. Some computing devices are portable such as smartphones, tablets and laptop computers. In addition to the primary function of these devices, many include elements that support peripheral functions. For example, a cellular telephone may include the primary function of enabling and supporting cellular telephone calls and the peripheral functions of a still camera, a video camera, a music player, global positioning system (GPS) navigation, web browsing, sending and receiving emails, sending and receiving text messages, push-to-talk capabilities, etc.

Some conventional designs for handheld portable computing devices include multiple processors of different types (such as central processing unit, graphics processing unit, display controller, hardware accelerators, etc.) and/or processors with multiple cores to support the various primary and peripheral functions desired for a particular computing device. Such designs often further integrate analog, digital and radio-frequency circuits or functions on a single silicon substrate and are commonly referred to as a system on a chip (SoC). These conventional designs often share a general-purpose memory resource such as a dynamic random access memory (DRAM) and non-volatile memory device. While sharing of DRAM among masters on the same SoC is straightforward and common in mobile devices, sharing of non-volatile memory is much harder and generally accomplished via a master-client approach. In such an approach, a processor or master is responsible for booting, loading, and executing a high-level operating system that includes a file system. The booting processor or master is considered the owning master of the file system. In such sharing schemes, any client, which is often another processing resource on the SoC, intending to use the non-volatile memory in the system needs to send requests to the owning master to access data stored in the non-volatile memory on its behalf.

While systems that deploy such centralized control of non-volatile memory are often well managed, these sharing schemes use a single file system, resulting in a less efficient use of the resource. In addition to the need for potential file format or other data conversions, a master-client architecture also introduces overhead latency as the master receives requests and in some cases arbitrates access to the non-volatile memory before processing the request and return the requested data to the client (i.e., hardware or software). More importantly, when the master is an application processing system (APS) with a multi-core processor, as long as a client is operating and accessing anon-volatile memory device, the APS cannot be powered down or operated in a low-power consumption state without significantly decreasing system and/or client responsiveness.

Moreover, since DRAM memory is much more expensive than non-volatile memory, there are constant market pressures to reduce the amount of DRAM memory needed to run an application or foot print in a portable computing platform such as smartphone. One approach to reduce an application's DRAM memory footprint includes identifying instructions and data that are infrequently needed by the application during execution and storing these in a solid-state non-volatile memory such as a NAND flash, NOR flash, phase-changed memory (PCM), Magneto-resistive random access memory (MRAM), and Spin Transfer Torque random access memory (SST RAM). This approach can achieve significant cost savings as non-volatile memory devices are much less expensive than DRAM. For example, a multi-level cell NAND flash storage is approximately ten-fold less expensive per bit than a DRAM. However, unlike DRAM, current non-volatile memory devices do not support virtualization since they only support a single context. Accordingly, the sharing model of non-volatile memory resources, such as flash-based memory resources, is restricted to the master-client architecture described above.

Thus, there is a need for improved mechanisms for sharing a relatively inexpensive non-volatile memory resource and conserving power within a portable computing system such as a smartphone.

### SUMMARY OF THE DISCLOSURE

Alternative embodiments of computing systems and methods for exposing a solid-state non-volatile memory to multiple masters in a portable computing device are disclosed. Each of the alternative embodiments includes a first processing resource or boot master that initializes the computing system and at least one non-boot processing resource. The boot master and the non-boot processing resource(s) are in communication with a volatile memory element and a non-volatile memory element by way of an interconnecting bus and respective controllers. In an example embodiment, the volatile memory element is a dynamic random-access memory (DRAM) and the non-volatile memory element is a solid-state non-volatile memory element such as a NAND flash memory device. As explained in detail in association with the illustrated embodiments, the computing systems and methods can be enabled using managed flash or unmanaged NAND flash. Unmanaged NAND flash is often also referred to as raw NAND flash. The controller coupled to the solid-state NAND flash memory device is modified to include logic that identifies which of the boot master and the non-boot processing resource(s) is accessing the solid-state non-volatile memory element. A portion of the solid-state non-volatile memory device is used to store code and data for use by the non-boot processing resource.

An example embodiment includes a portable computing device enabled in a SoC. The SoC includes a first processing resource or boot master and at least one non-boot processing resource. An interface bus communicates with both the boot master and the non-boot processing resource as well a first controller coupled to a DRAM element and a second or host controller coupled to a solid-state non-volatile memory element. The boot master is configured to allocate storage in DRAM for a set of indicators. The solid-state non-volatile memory has stored therein code and data dedicated for execution and use by the at least one non-boot processing resource. The set of indicators reflect an operational condition of the solid-state non-volatile memory element and an operational condition of the non-boot processing resource. The SoC executes logic with the at least one non-boot processing resource to expose the code and data dedicated for execution and use by the at least one non-boot processing resource or executes logic with the boot master to expose content other than the code and data dedicated for execution and use by the at least one non-boot processing resource from the solid-state non-volatile memory element.

One example embodiment includes a portable computing device with a first processing resource or boot master and at least one non-boot processing resource. A controller manages data transfers to and read access from a solid-state non-volatile memory element. The controller is responsive to an identifier associated with one of a boot master and at least one non-boot processing resource. A solid-state non-volatile memory element coupled to the controller includes a portion having stored therein code and data for use by the at least one non-boot processing resource. The portable computing device monitors an operational condition of the solid state non-volatile memory element and an operational condition of the at least one non-boot processing resource. The portable computing device is arranged to conditionally execute logic with the at least one non-boot processing resource to expose the code and data for use by the at least one non-boot processing resource or execute logic with the boot master to expose content other than the code and data for use by the at least one non-boot processing resource from the solid-state non-volatile memory element.

Another example embodiment is a method for exposing a solid-state memory to multiple masters in a portable computing device. The portable computing device includes a first processing resource or boot master and at least one non-boot processing resource. The method includes the steps of identifying a boot master in communication with a first memory element, identifying content useful to a non-boot processing resource, storing the content useful to the non-boot processing resource in a solid-state non-volatile memory element in the portable computing device, generating a set of indicators responsive to an operational condition of the solid-state non-volatile memory element and further responsive to an operational condition of the non-boot processing resource and conditionally executing logic with one of the non-boot processing resource to expose the content useful to the non-boot processing resource or executing logic with the boot master to expose content other than the content useful to the non-boot processing resource from the solid-state non-volatile memory element.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a schematic diagram illustrating an example portable computing device.

FIG. 2 is a schematic diagram illustrating an example portable computing device where content stored in a solid-state non-volatile memory element is logically exposed to one or more alternate masters.

FIG. 3A is a flow diagram illustrating an example embodiment of a method for initializing the portable computing device of FIG. 6.

FIG. 3B is a flow diagram illustrating an example embodiment of a method for initializing the portable computing device of FIG. 2.

FIG. 4 is a flow diagram illustrating an example embodiment of a method for a non-boot processing resource to access content in the solid-state non-volatile memory element of FIG. 2.

FIG. 5 is a is a flow diagram illustrating an example embodiment of a method for a boot master to access content in the solid-state non-volatile memory element of FIG. 2.

FIG. 6 is a schematic diagram illustrating an alternative embodiment of a portable computing device where content stored in a solid-state non-volatile memory element is exposed to one or more alternate masters.

FIG. 7 is a flow diagram illustrating an example embodiment of a method for a boot master to access content in the solid-state non-volatile memory element of FIG. 6.

FIG. 8 is a schematic diagram illustrating an embodiment of a device managed solid-state non-volatile memory element.

FIGS. 9A and 9B include respective schematic diagrams illustrating embodiments of unmanaged solid-state non-volatile memory elements.

FIG. 10 is a flowchart illustrating an example embodiment of a method for exposing a solid-state non-volatile memory element to multiple masters in a portable computing device.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files or data values that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer-readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the term “portable computing device” or PCD is used to describe any device operating on a limited capacity rechargeable power source, such as a battery and/or capacitor. Although PCDs with rechargeable power sources have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop or tablet computer with a wireless connection, among others.

A portable computing device and methods for exposing a solid-state non-volatile memory to multiple masters in a portable computing device are disclosed. The described embodiments are not so limited and are transferrable to desktop and server computers. In an initialization procedure, a segment or portion of a solid-state non-volatile memory element is identified or set aside for content for use for an identified non-boot processing resource. The segment or portion of the solid-state non-volatile memory element includes code and data for use by the non-boot processing resource.

In an example embodiment, a host controller in communication with the solid-state non-volatile memory element is modified to respond to a resource identifier unique to the processing resource that is requesting read access to the solid-state memory. The host controller is further modified to generate and communicate a modified read command/request. The solid-state non-volatile memory device is modified to recognize and conditionally process read requests based on the identity of the requesting resource. Upon receipt of a read request, the host controller compares the resource identifier in the request with previously registered or stored identifiers associated with non-boot processing resources. When the host controller detects a match, the host controller will generate a modified read request that is communicated to the solid-state non-volatile memory element. When the solid-state non-volatile memory element receives the modified request, the request will bypass the address translation layer in the solid-state non-volatile memory and access the solid-state storage that is reserved for the non-booting master directly using the address or addresses in the modified read request. One or more partitions or instances of these storage areas may be configured. Logic executed by a boot master and logic executed by a non-boot processing resource, when the boot master or a non-boot processing resource is attempting to access or read information stored in the solid-state nonvolatile memory element, are synchronized in response to a set of indicators. The indicators are stored in a shared memory such as in a system memory semaphore. When the host controller and the solid-state non-volatile memory element are modified as described above, the in-memory semaphore or set of indicators may be allocated and configured in conjunction with or upon completion of a system initialization or reset procedure.

Data communicated from the solid-state non-volatile memory element in response to the modified read request will be error checked and corrected as needed when errors are indicated and the errors are correctable. When errors are identified and not correctable, the host controller may communicate an error condition to the identified non-boot processing resource. When a spare partition or segment is available, the host controller is arranged to mark the primary or default partition as bad and use content stored in the spare partition or segment.

In an alternative embodiment, the host controller and the solid-state non-volatile memory element remain unchanged. In this alternative embodiment, code and data for use by anon-boot processing resource is exposed logically from the solid-state non-volatile memory element to the non-boot processing resource by way of a map or translation that a boot master generates and stores in the volatile memory element when the computing system is initialized. The location(s) in the volatile memory element (i.e., a dedicated segment or portion of the solid-state non-volatile memory element) is logically exposed to the non-boot processing resource, which uses the physical locations stored therein to instruct the host controller where to find the data of interest in the solid-state non-volatile memory element. Logic executed by the boot master and respective logic executed by the non-boot processing resource, when the boot master or the non-boot processing resource is attempting to access or read information stored in the solid-state nonvolatile memory element, are synchronized in response to a set of indicators. The indicators are stored in a shared memory such as in a system memory semaphore.

Although described with particular reference to operation within a portable computing device (PCD), the described systems and methods for exposing a solid-state non-volatile memory device to multiple masters are applicable to any computing system with separate processing resources. Stated another way, the systems and methods for exposing a solid-state non-volatile memory element such as a NAND or NOR flash storage device whether managed or unmanaged are applicable to desktop computers, server computers or any electronic device with multiple processing resources.

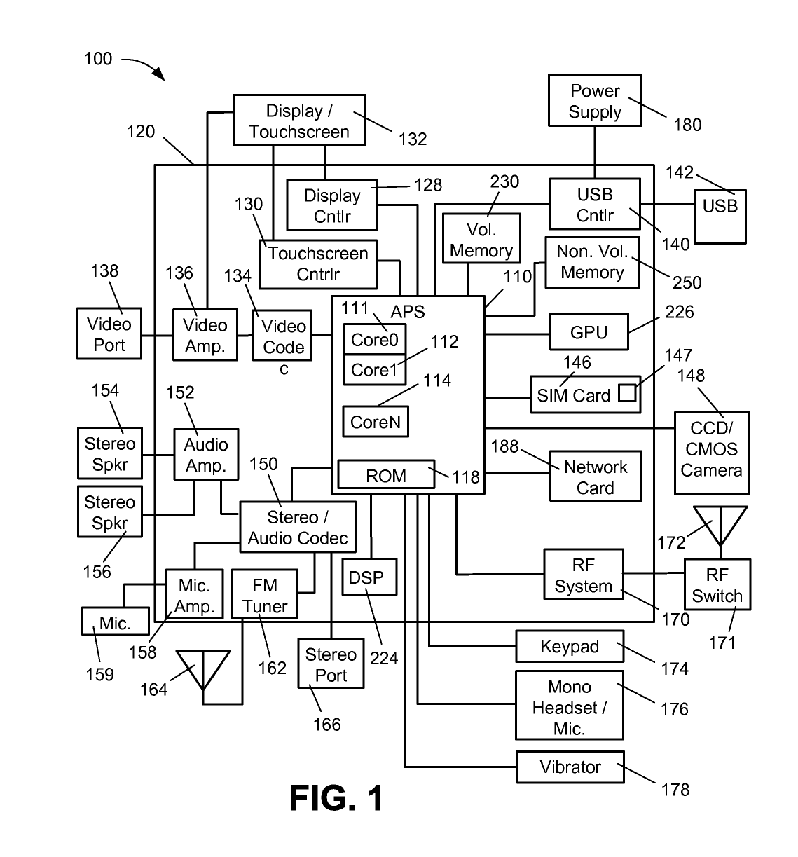

Reference is now directed to the illustrated examples. Referring initially to FIG. 1, an exemplary, non-limiting aspect of a portable computing device (PCD) is shown and is generally designated 100. As shown, the PCD 100 includes a system-on-chip (SoC) 120 that includes a multicore CPU or application processing system (APS) 110. The APS 110 includes a zero^{th} core 111, a 1^{st} or first core 112, and an N^{th} core 114. The cores or processing resources 111-114 are shared processing resources that support the execution of an operating system, background functions, and one or more applications or programs on the PCD 100. The APS 110 works in conjunction with instructions and data stored in read-only memory (ROM) 118 to initialize or configure the PCD 100 upon applying power to the various elements from power supply 180.

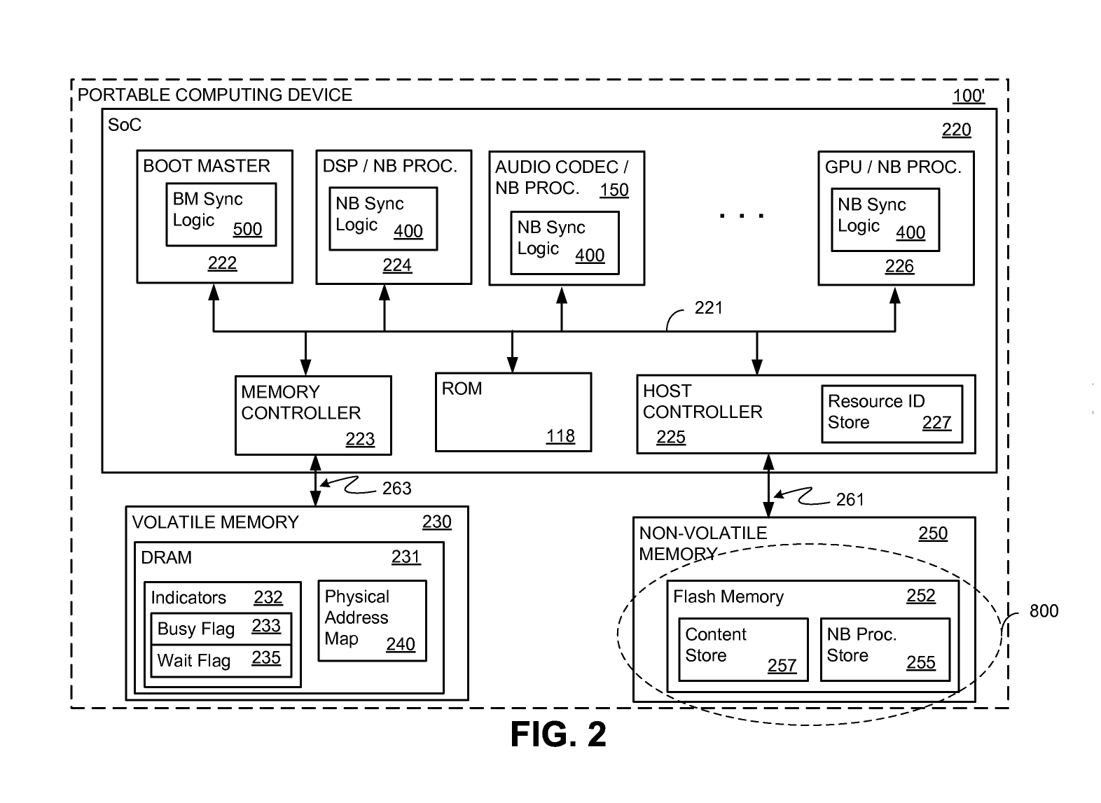

The PCD 100 includes a number of other processing resources that are enabled as may be required after the APS 110 is active. Hereafter, these other processing resources will be referred to as non-boot processing resources. Some example non-boot processing resources include but are not limited to a digital signal processor (DSP) 224, a graphics processing unit (GPU) 226, Stereo/Audio Codec 150, Video Codec 134, among other processors in the SoC 120. As will be explained in greater detail in association with FIGS. 2-10, these and other non-boot processing resources may be powered on and at appropriate times will controllably access respective portions of a non-volatile memory element 250 to retrieve content for use in or by the respective non-boot processing resource. The APS 110 and the respective non-boot processing resources are arranged with logic that enables each resource to act as a master to access the non-volatile memory 250.

As illustrated in FIG. 1, a display controller 128 and a touch screen controller 130 are coupled to the APS 110. In turn, display/touchscreen 132, external to the SoC 120, is coupled to the display controller 128 and the touch screen controller 130. A video CODEC 134, e.g., a phase alternating line (PAL) encoder, a sequential couleur a memoire (SECAM) encoder, or a national television system(s) committee (NTSC) encoder, is coupled to the APS 110. Further, a video amplifier 136 is coupled to the video CODEC 134 and the display/touchscreen 132. Also, a video port 138 is coupled to the video amplifier 136. As depicted in FIG. 1, a universal serial bus (USB) controller 140 is coupled to the APS 110. Also, a USB port 142 is coupled to the USB controller 140. A volatile system memory 230, a non-volatile system memory 250 and a subscriber identity module (SIM) card 146 may also be coupled to the APS 110. Further, as shown in FIG. 1, a digital camera 148 may be coupled to the APS 110. In an exemplary aspect, the digital camera 148 is a charge-coupled device (CCD) camera or a complementary metal-oxide semiconductor (CMOS) camera.

As further illustrated in FIG. 1, a stereo audio CODEC 150 may be coupled to the APS 110. Moreover, an audio amplifier 152 may be coupled to the stereo audio CODEC 150. In an exemplary aspect, a first stereo speaker 154 and a second stereo speaker 156 are coupled to the audio amplifier 152. The illustrated embodiment shows that a microphone amplifier 158 may be also coupled to the stereo audio CODEC 150. Additionally, a microphone 159 may be coupled to the microphone amplifier 158. In a particular aspect, a frequency modulation (FM) radio tuner 162 may be coupled to the stereo audio CODEC 150. Also, a FM antenna 164 is coupled to the FM radio tuner 162. Further, a stereo port 166 may be coupled to the stereo audio CODEC 150.

FIG. 1 also indicates that a radio frequency (RF) system or transceiver 170 is coupled to the APS 110. An RF switch 171 may be coupled to the RF system 170 and an RF antenna 172. As shown in FIG. 1, a keypad 174 is coupled to the APS 110. Also, a mono headset with a microphone 176 may be coupled to the APS 110. Further, a vibrator device 178 may be coupled to the APS 110. FIG. 1 further shows that a power supply 180 is coupled to the SoC 120 via the USB controller 140. In a particular aspect, the power supply 180 is a direct current (DC) power supply that provides power to the various components of the PCD 100 that require power. Further, in a particular aspect, the power supply is a rechargeable DC battery or a DC power supply that is derived from an alternating current (AC) to DC transformer that is connected to an AC power source.

FIG. 1 further indicates that the PCD 100 may also include a network card 188 that may be used to access a data network, e.g., a local area network, a personal area network, or any other network. The network card 188 may be a Bluetooth network card, a WiFi network card, a personal area network (PAN) card, or any other network card well known in the art. Further, the network card 188 may be incorporated in an integrated circuit. That is, the network card 188 may be a full solution in a chip, and may not be a separate network card 188.

As depicted in FIG. 1, the display/touchscreen 132, the video port 138, the USB port 142, the camera 148, the first stereo speaker 154, the second stereo speaker 156, the microphone 159, the FM antenna 164, the stereo port 166, the RF switch 171, the RF antenna 172, the keypad 174, the mono headset 176, the vibrator 178, and the power supply 180 are external to the SoC 120.

RF system or transceiver 170, which may include one or more modems, may support one or more of global system for mobile communications (“GSM”), code division multiple access (“CDMA”), wideband code division multiple access (“W-CDMA”), time division synchronous code division multiple access (“TDSCDMA”), long term evolution (“LTE”), and variations of LTE such as, but not limited to, FDB/LTE, PDD/LTE, and future wireless protocols.

In the illustrated embodiment, a single instance of an APS 110 is depicted. However, it should be understood that any number of similarly configured APSs can be included to support the various peripheral devices and functions associated with the PCD 100. Alternatively, a single processor or multiple processors each having a single arithmetic logic unit or core could be deployed in a PCD or other computing devices to support the various peripheral devices and functions associated with the PCD 100 as may be desired.

In a particular aspect, one or more of the method steps described herein may be enabled via a combination of data and processor instructions stored in the ROM 118, the non-volatile system memory 250 or the volatile memory 230. These instructions may be executed by the APS 110 or one or more of the non-boot processing resources in order to perform the methods described herein. Further, the APS 110, ROM 118, volatile memory 230, non-volatile memory 250, an EEPROM (not shown) or a combination thereof may serve as a means for storing a non-transitory representation of boot or initialization logic, including resource state logic, and configuration parameters for executing one or more of the method steps described herein.

FIG. 2 is a schematic diagram illustrating an example portable computing device 100′ where content stored in a solid-state non-volatile memory element 250 is logically exposed to one or more alternative masters. The alternative masters in the illustrated embodiment include an audio codec 150, a DSP 224, and a GPU 226. Other arrangements may include different combinations including these non-boot processing resources or combinations not including these resources. Still other arrangements may include any desired number of non-boot processing resources.

The portable computing device 100′ is arranged with a SoC 220 that includes boot master 222, DSP 224, audio codec 150 and GPU 226 among other non-boot processing processors. The boot master 222 and non-boot processing resources are coupled to each other and to memory controller 223 and host controller 225 via a communication bus 221.

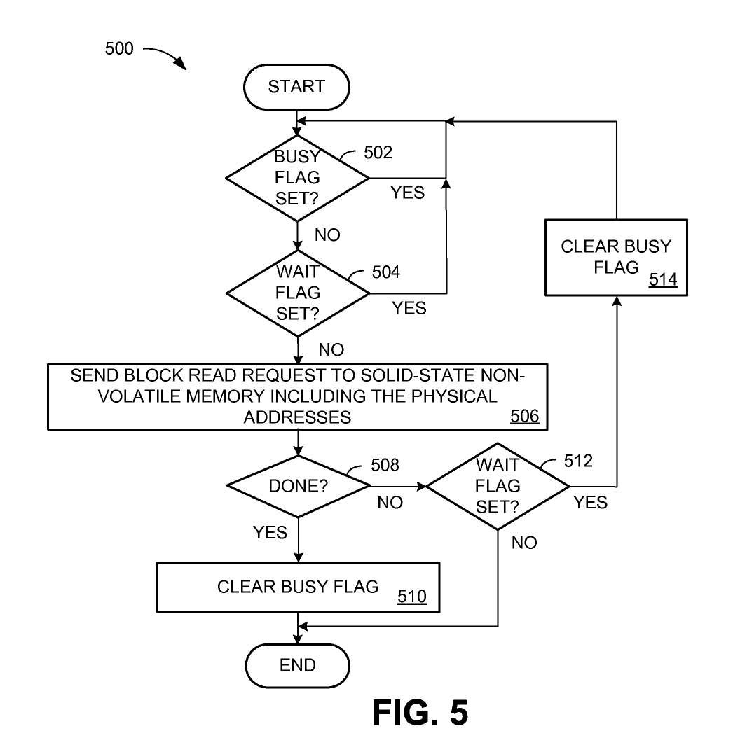

The boot master 222 is a processing resource that is arranged to initialize the portable computing device 100′ upon either the application of power to the boot master 222 or upon a reset command that may avoid a power-on test. The boot master 222 is responsive to configuration information in ROM 118 that instructs the boot master 222 to load an operating system from a persistent memory. In some arrangements the persistent memory may include a portion of the non-volatile memory 250. The boot master 222 further includes boot master specific synchronization logic or BM sync logic 500 that when executed is both responsive to a set of indicators 232, and under appropriate conditions, resets or clears an indicator among the set of indicators 232 to manage data transfers between the non-boot processing resources and the non-volatile memory 250. An example embodiment of the BM sync logic 500 is described in further detail in association with the flow diagram illustrated in FIG. 5.

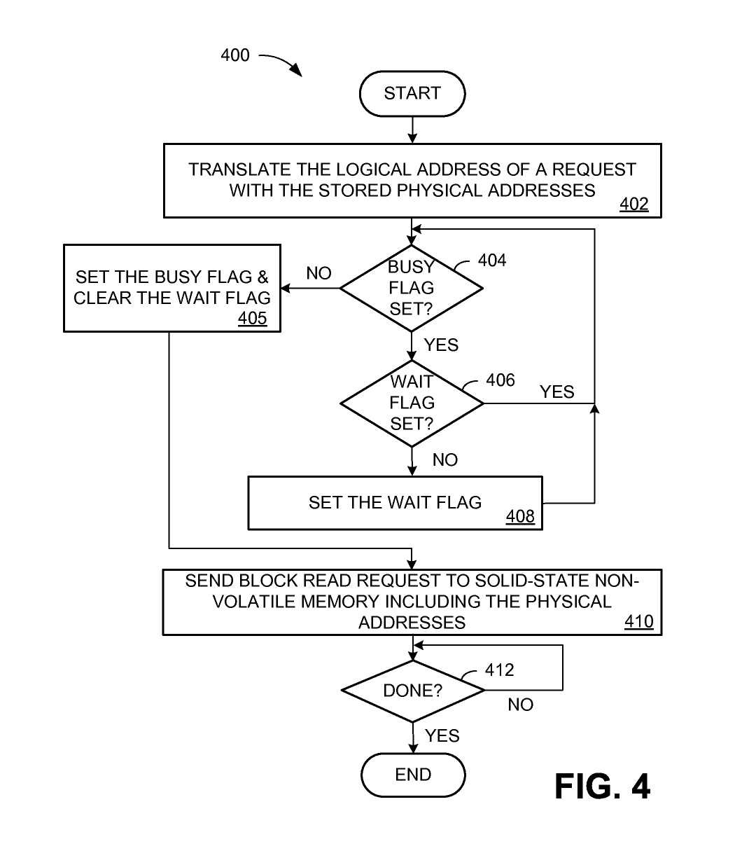

In contrast with the boot master 222, the non-boot processing resources such as the DSP 224, audio codec 150 and GPU 226 are processing resources that perform dedicated functions in accordance with one or more programs operating on the portable computing device 100′. Each of the non-boot processing resources include among other device specific functions non-boot (NB) sync logic 400 that when executed is both responsive to a set of indicators 232, and under appropriate conditions, sets or manipulates indicators, among the set of indicators 232, to manage data transfers between the non-boot processing resources and the non-volatile memory 250. An example embodiment of the NB sync logic 500 is described in further detail in association with the flow diagram illustrated in FIG. 4.

In addition, each of the non-boot processing resources may include respective circuits or logic (624, 626, 650) that provides a mechanism for monitoring an operational condition of the respective non-boot processing resource. The operational condition may include when the non-boot processing resource is actively communicating with the non-volatile memory element 250 by way of the host controller 225. Alternatively, the host controller 225 and more specifically the modified read request logic 229 may be arranged to provide a mechanism for monitoring and reporting an operational condition of the respective non-boot processing resources in the SoC.

The host controller 225 is coupled via interface 261 to the non-volatile memory 250 which may be a NAND flash memory 252. The host controller 225 is arranged with hardware elements that expose the non-volatile memory 250 with processing resources in or communicatively coupled to the SoC 220. The host controller 225 provides a mechanism for controlling data transfers to and read access from a solid-state non-volatile memory element(s). Furthermore, the host controller 225 provides a mechanism for controlling that is responsive to one of the boot master 222 and at least one non-boot processing resource 150, 224, 226.

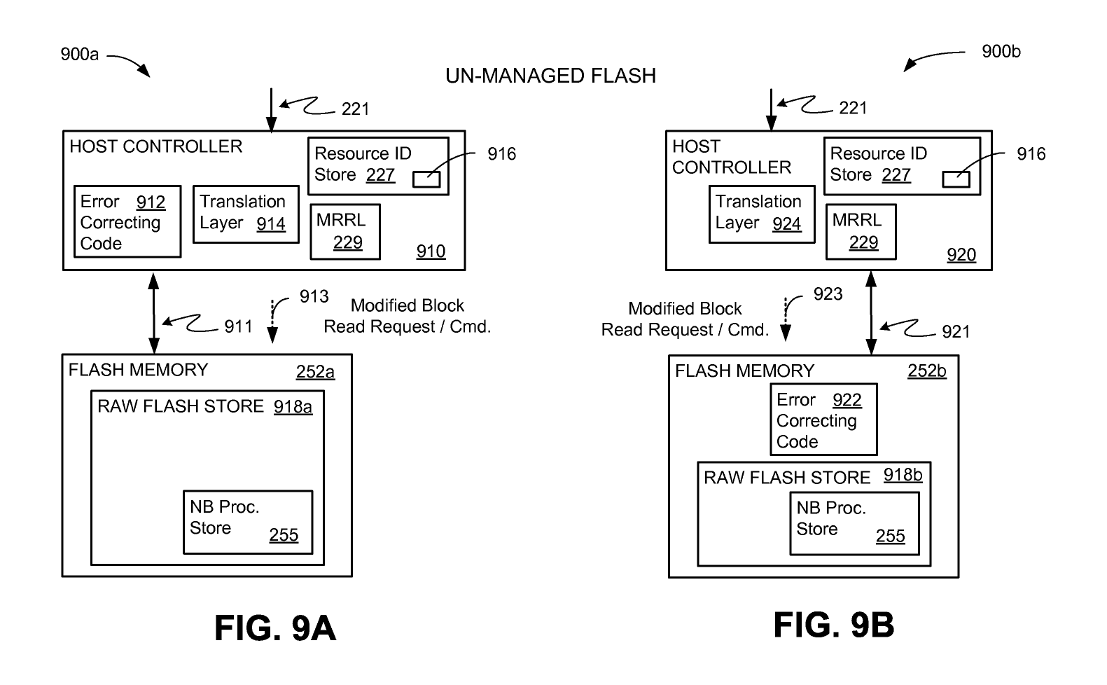

The host controller 225 is arranged with a resource identifier store 227, which includes an identifier respectively associated with a non-boot processing resource. The resource identifier store 227 may be a register or a set of registers arranged to store the identifier(s). In the illustrated embodiment, the resource identifier store 227 is a component part of the host controller 225. However, the register or set of registers forming the resource identifier store 227 may be relocated in other locations of the SoC 220 that can be accessed by the host controller 225. As indicated in FIG. 2 by way of broken line 900 further details of the flash memory 252 are described in association with the description of FIG. 9, which illustrates a managed flash embodiment.

The interface 261 provides a mechanism for monitoring when the solid-state non-volatile memory element 250 is transferring information to the processing resources. The interface 261 transfers control, timing and data signals between the host controller 225 and the non-volatile memory 250.

The memory controller 223 is coupled to volatile memory 230 via interface 263. In the illustrated example, the volatile memory 230 is a DRAM 231 that includes a set of indicators 232 and a physical address map 240. The set of indicators 232 includes a busy flag 233 and further includes a wait flag 235. As further illustrated in FIG. 2, a physical address map 240 is also stored in the DRAM 231. The physical address map 240 identifies a set of addresses or storage locations in the flash memory 252 and more specifically a set of addresses or storage locations associated with the NB processor store 255.

Moreover, the physical address map 240 includes a translation of logical addresses as understood or exposed to the boot master 222 and application software functioning in accordance with an operating system on the portable computing device 100′ into physical addresses or locations in the flash memory 252.

The NB processor store 255 includes an identified set of physical data storage locations in blocks or other storage divisions recognized by the host controller 225 or in the case of a managed flash device by an embedded flash controller. The flash memory 252 includes circuits and firmware that controllably manage stored data to ensure data storage segments or portions commonly referred to as blocks are written to evenly. The circuits and firmware provide a mechanism for segregating a portion, such as NB processing store 255, of a solid-state non-volatile memory element 250 for the storage of instructions, files, configuration or other data for exclusive use by an identified non-boot processing resource 150, 224, 226. Although a single instance of a NB processor store 255 is shown, each non-boot processor in the SoC 220 may be associated with a dedicated portion of the memory capacity of the flash memory 252 to store processor specific content or information useful to the associated non-boot processing resource. The content useful to the non-boot processing resource may include instructions, configuration information, files or other data.

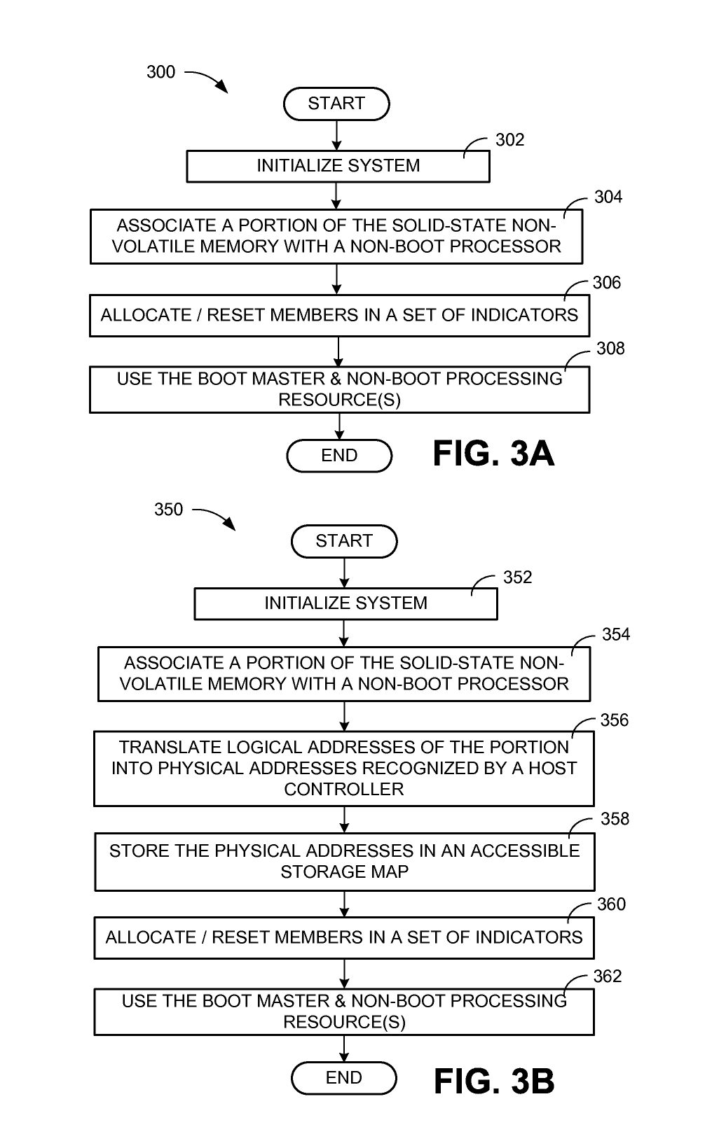

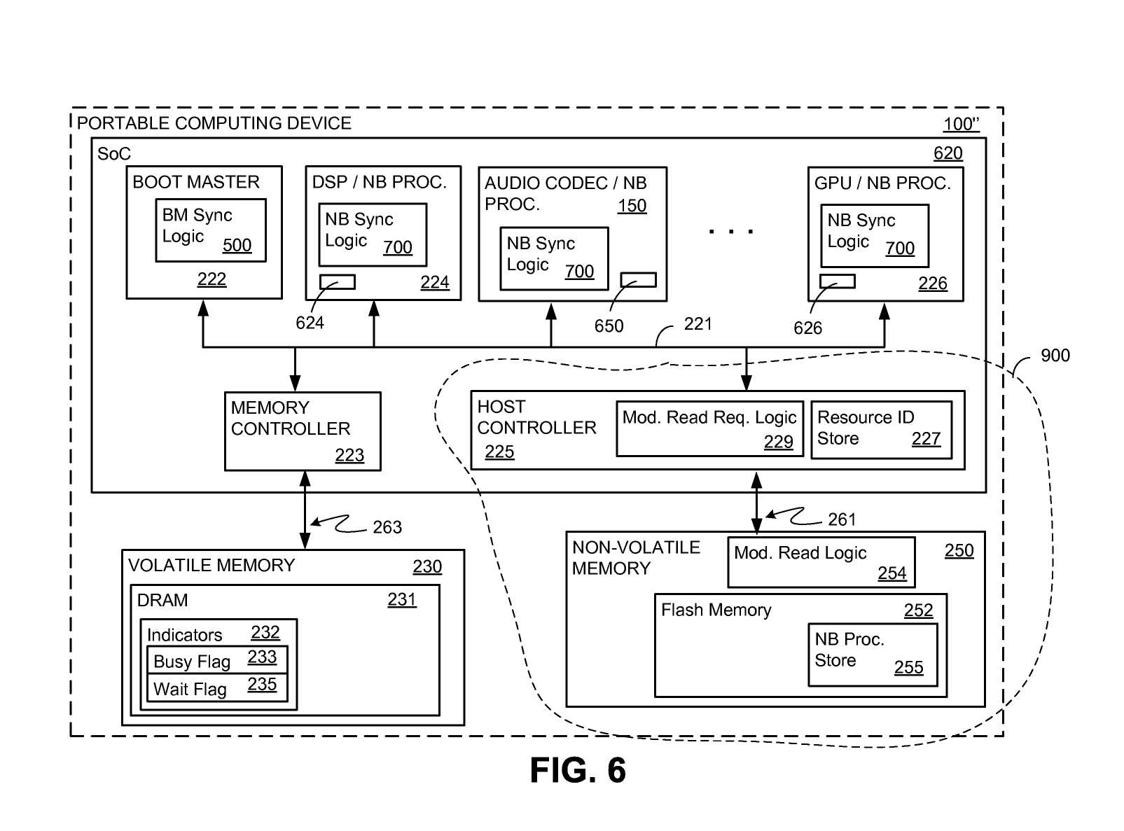

FIG. 3A is a flow diagram illustrating an example embodiment of a method 300 for initializing or booting the portable computing device 100″ of FIG. 6. That is, the method 300 initializes an embodiment of the SoC 620 that includes a modified host controller 225 and a modified non-volatile memory element 250 as briefly described above and as illustrated and described in further detail in association with the embodiment in FIG. 6.

The method 300 begins with block 302 where power is applied the PCD 100″ and instructions in a read-only memory 118 are executed by the APS 110 to load an operating system into volatile memory element 230. As indicated in block 304, the a portion (e.g., NB processor store 255) of the solid-state non-volatile memory 252 is associated with a non-boot processing resource. In block 306, the PCD 100″ allocates and stores an initial value in a set of indicators in a shared memory. Thereafter, as indicated in block 308, the PCD 100″ uses one or more of the boot master 222 and non-boot processing resource(s) 150, 224, 226 to execute one or more programs with the PCD 100″ as may be desired.

FIG. 3B illustrates an example embodiment of a method 350 for initializing or booting the portable computing device 100′ of FIG. 2. That is, the method 350 initializes an embodiment of the SoC 220 that includes a host controller 225 responsive to a processing resource identifier stored in a resource ID store 227 and an unmodified non-volatile memory element 250 as described above in association with the embodiment in FIG. 2.

The method 350 begins with block 352 where power is applied the PCD 100′ and instructions in ROM 118 are executed by the APS 110 to load an operating system into volatile memory element 230. As indicated in block 354, a portion (e.g., NB processor store 255) of the solid-state non-volatile memory 252 is associated with a non-boot processing resource. In block 356, boot master 222 translates logical addresses of the shared volatile memory 230 with physical addresses recognized by the host controller 225 as identifying locations in the NB processor store 255. In block 358, the physical addresses are stored in a map 240 accessible to the boot master and each of the non-boot processing resources 150, 224, 226. In block 360, the PCD 100′ and more specifically the boot master 222, allocates and stores an initial value in a set of indicators in the volatile memory 230. Thereafter, as indicated in block 362, the PCD 100′ uses one or more of the boot master and non-boot processing resource(s) to execute one or more programs with the PCD 100″ as may be desired.

FIG. 4 is a flow diagram illustrating an example embodiment of a method 400 for a non-boot processing resource (e.g., DSP 224, Audio Codec 150, GPU 226, etc.) to access content set aside in the solid-state non-volatile memory element 252 of FIG. 2. The method 400 begins with block 402a translation of the logical address of a read request is made to identify the corresponding physical locations in the solid-state non-volatile memory element 252. Thereafter, a first query, as indicated in decision block 402, is performed where the state of the busy flag is checked. When the busy flag is not set, the non-boot processing resource or alternate master sets the busy flag and clears the wait flag, as indicated by the flow control arrow labeled “no,” exiting decision block 402 and as shown in block 405. Thereafter, as indicated in block 410, the non-boot processing resource or alternate master sends a block read request to the solid-state non-volatile memory element 252 including the physical locations associated with the non-boot processor store 255. As indicated in decision block 412, the non-boot processing resource performs a query to determine if the read operation is complete. When the read operation is complete the method 400 terminates. Otherwise, when the read operation is pending, as indicated by the flow control arrow labeled, “no” exiting decision block 412, the non-boot processing resource is directed to repeat the read operation status check. An optional wait statement or delay can be inserted to prevent throttling as may be desired.

Otherwise, when the busy flag is set, as indicated by the flow control arrow labeled, “yes,” exiting decision block 404, the non-boot processing resource or alternate master moves to the second query, as indicated in decision block 406, where the state of the wait flag is checked. When the wait flag is set the non-boot processing resource or alternate master repeats the checks of the respective states of the busy flag and the wait flag, as indicated by the flow control arrow labeled “yes,” exiting decision block 406. A wait flag set condition indicates that the non-boot processing resource 150, 224, 226 is waiting for the boot master 222 to complete a presently active access of the solid-state non-volatile memory element 252. Otherwise, when the wait flag is not set the non-boot processing resource or alternate master sets the wait flag, as indicated in block 408 before repeating the checks of the respective states of the busy flag and the wait flag. An optional wait statement or delay can be inserted to prevent throttling as may be desired.

FIG. 5 is a flow diagram illustrating an example embodiment of a method 500 for a boot master 222 to access content in portions other than the set-aside non-boot processor store 255 in the solid-state non-volatile memory element 252 of FIG. 2. The method 500 begins with a first query, as indicated in decision block 502, where the state of the busy flag is checked. When the busy flag is set the boot master 222 repeats the check as indicated by the flow control arrow labeled “yes,” exiting decision block 502. An optional wait statement or delay can be inserted to prevent throttling as may be desired. Otherwise, when the busy flag is not set, the boot master 222 moves to the second query, as indicated in decision block 504, where the state of the wait flag is checked. When the wait flag is set the boot master 222 repeats the checks of the respective states of the busy flag and the wait flag, as indicated by the flow control arrow labeled “yes,” exiting decision block 504. Again, an optional wait statement or delay can be inserted to prevent throttling as may be desired.

Otherwise, when the wait flag is not set, the boot master 222 directs the host controller 225 to generate a read request including the physical locations as recognized by the solid-state non-volatile memory element 252, as indicated in block 506. In decision block 508, a query is performed to determine if the read operation is complete. When the read operation is complete, the boot master 222 clears the busy flag as indicated in block 510 and the method 500 terminates. Otherwise, when the read operation is not complete, the boot master 222 determines if one of the non-boot processing resources has set the wait flag, as shown in decision block 512. When the wait flag is set and one of the non-boot processing resources is requesting access to the solid-state non-volatile memory element, the boot master 222 clears the busy flag, as indicated in block 514, thereby relinquishing control to the one or more non-boot processing resources that may be queued and waiting for the respective content in the solid-state non-volatile memory element 252.

FIG. 6 is a schematic diagram illustrating an alternative embodiment of a portable computing device 100″ where content stored in a solid-state non-volatile memory element, such as in flash memory 252, is exposed to one or more alternative masters through a modified read request or command. The alternative masters in the illustrated embodiment include an audio codec 150, a DSP 224, and a GPU 226. Other arrangements may include different combinations including these non-boot processing resources or combinations not including these resources. Still other arrangements may include any desired number of non-boot processing resources.

The portable computing device 100″ is arranged with a SoC 620 that includes boot master 222, DSP 224, audio codec 150 and GPU 226 among other non-boot processing processors. The boot master 222 and non-boot processing resources are coupled to each other and to memory controller 223 and host controller 625 via a communication bus 221.

The boot master 222 is a processing resource that is arranged to initialize the portable computing device 100″ upon either the application of power to the boot master 222 or upon a reset command that may avoid a power-on test. The boot master 222 is responsive to configuration information in a read-only memory (not shown) that instructs the boot master 222 to load an operating system from a persistent memory. In some arrangements the persistent memory may include a portion of the non-volatile memory 250. The boot master 222 further includes boot master specific synchronization logic or BM sync logic 500 that when executed is both responsive to a set of indicators 232, and under appropriate conditions, resets or clears an indicator among the set of indicators 232 to manage data transfers between the non-boot processing resources and the non-volatile memory 250.

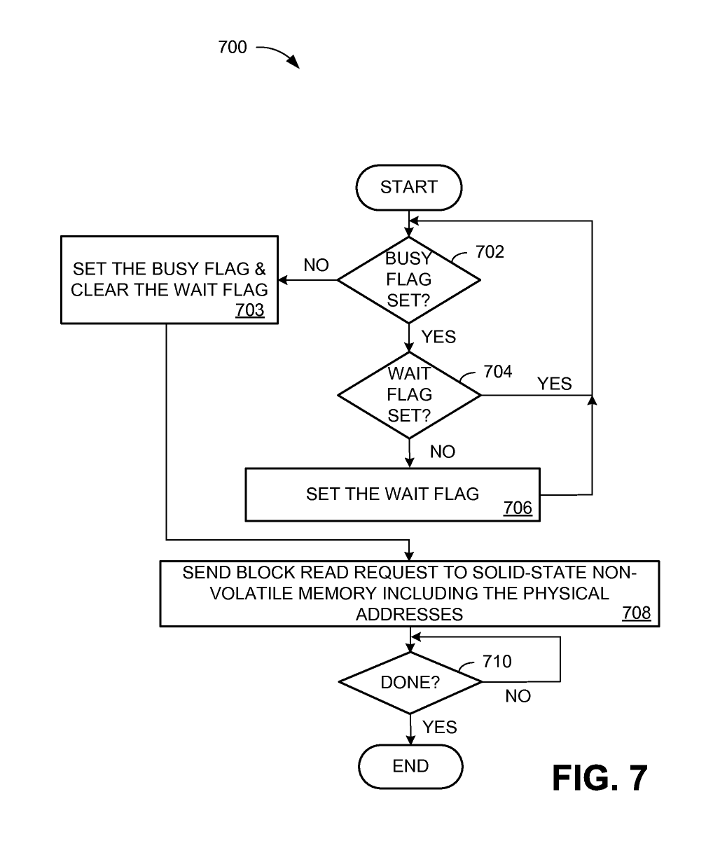

In contrast with the boot master 222, the non-boot processing resources such as the DSP 224, audio codec 150 and GPU 226 are processing resources that perform dedicated functions in accordance with one or more programs operating on the portable computing device 100″. Each of the non-boot processing resources include among other device specific functions non-boot (NB) sync logic 700 that when executed is both responsive to a set of indicators 232, and under appropriate conditions, sets or manipulates indicators, among the set of indicators 232, to manage data transfers between the non-boot processing resources and the non-volatile memory 250. An example embodiment of the NB sync logic 700 is described in further detail in association with the flow diagram illustrated in FIG. 7.

As indicated in FIG. 6, the memory controller 223 is coupled to volatile memory 230 via interface 263. In the illustrated example, the volatile memory 230 is a DRAM 231 that includes a set of indicators 232. The set of indicators 232 includes a busy flag 233 and further includes a wait flag 235. The busy flag 233 and wait flag 235 are set and read at designated times or under specified conditions by the NB sync logic 700 and the BM sync logic 500 to synchronize which processing resource or master is communicating with the non-volatile memory 250.

The host controller 625 is coupled via interface 261 to the non-volatile memory 250 which may be a NAND flash memory 252. The host controller 625 is arranged with a resource identifier store 227, which includes an identifier respectively associated with a non-boot processing resource. The resource identifier store 227 may be a register or a set of registers arranged to store the identifier(s). In the illustrated embodiment, the resource identifier store 227 is a component part of the host controller 225. However, the register or set of registers forming the resource identifier store 227 may be relocated in other locations of the SoC 220 that can be accessed by the host controller 225. The host controller 625 is further arranged with modified read request logic 229, which is arranged to identify read requests initiated by the one or more non-boot processing resources and generate a modified read request or command. Modified read logic 254 in the non-volatile memory 250 is arranged to identify modified read requests or commands issued by the host controller 625 and to directly access appropriate blocks of the flash memory 252 that correspond to the NB processor store 255. The host controller 625 compares a request identifier received via a bus 221 with information in the resource identifier store 227 to identify the appropriate physical location(s) in the flash memory 252 to satisfy the read request. When the flash memory 252 is an unmanaged or raw flash memory with internal error correcting code, the modified read logic may be arranged to bypass the internal error correcting code. As indicated in FIG. 6 by way of broken line 1000 further details of the flash memory 252 are described in association with the description of FIG. 9A and FIG. 9B, which illustrate unmanaged or raw flash embodiments.

FIG. 7 is a flow diagram illustrating an example embodiment of a method 700 for a non-boot processing resource (e.g., DSP 224, Audio Codec 150, GPU 226, etc.) to access content set aside in the solid-state non-volatile memory element 252 of FIG. 6. The method 700 begins with a first query, as indicated in decision block 702, where the state of the busy flag is checked. When the busy flag is not set, the non-boot processing resource or alternate master sets the busy flag and clears the wait flag, as indicated by the flow control arrow labeled “no,” exiting decision block 702 and as shown in block 703. Thereafter, as indicated in block 708, the non-boot processing resource or alternate master sends a block read request to the solid-state non-volatile memory element 252 including the physical locations associated with the non-boot processor store 255. As indicated in decision block 710, the non-boot processing resource performs a query to determine if the read operation is complete. When the read operation is complete the method 700 terminates. Otherwise, when the read operation is pending, as indicated by the flow control arrow labeled, “no” exiting decision block 710, the non-boot processing resource is directed to repeat the read operation status check. An optional wait statement or delay can be inserted to prevent throttling as may be desired.

Otherwise, when the busy flag is set, as indicated by the flow control arrow labeled, “yes,” exiting decision block 702, the non-boot processing resource or alternate master moves to the second query, as indicated in decision block 704, where the state of the wait flag is checked. When the wait flag is set the non-boot processing resource or alternate master repeats the checks of the respective states of the busy flag and the wait flag, as indicated by the flow control arrow labeled “yes,” exiting decision block 704. An optional wait statement or delay can be inserted to prevent throttling as may be desired.

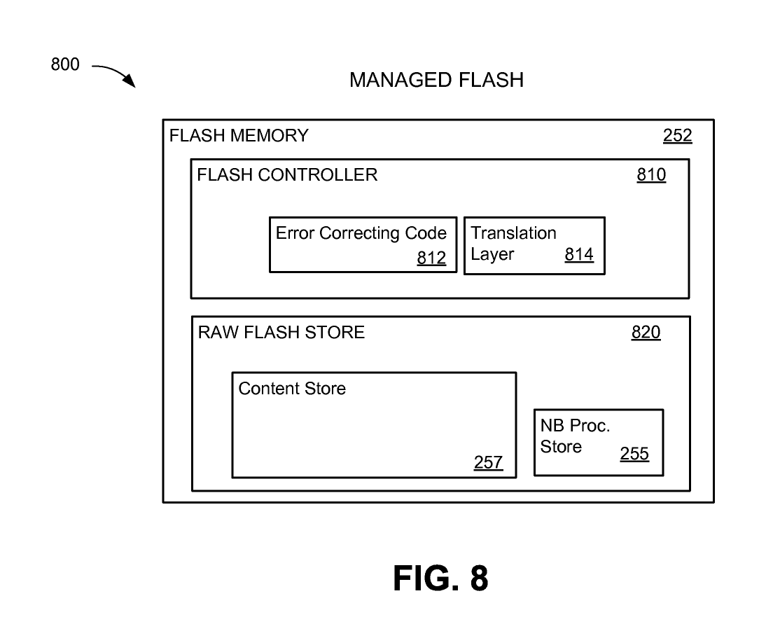

FIG. 8 is a schematic diagram illustrating an embodiment of a device managed solid-state non-volatile memory element or Flash memory 252. As shown in FIG. 8, a device managed Flash memory 252 includes a flash controller 810 and a raw flash store 820. The flash controller 810 includes error correcting code 812 and a translation layer 814. The error correcting code 812 is arranged to detect and correct bit errors that may occur with the raw memory. NAND flash memory bit error rates increase with the number of store and erase cycles and with the scaling of technology. Error correcting code (ECC) 812 decreases raw bit error rates and enhances the lifespan of NAND flash memory. ECC 812 can be implemented in firmware/software or in controller hardware.

The translation layer 814 includes interface logic that exposes flash blocks to a higher level operating system as logical sectors. The translation layer 814 includes code that manages unexpected system resets and manages wear or usage of the raw flash by distributing use of flash blocks evenly.

The raw flash store 820 includes a portion such as NB processor store 255 that is set aside for an identified non-boot processor arranged on or in communication with a computing device. That is, the NB processor store 255 includes executable instructions or data dedicated for use by the associated processing resource. The raw flash store 820 further includes a remaining portion or other content store 257 that is available for the boot master (e.g., an APS) or any other processing resource communicatively coupled to the computing device.

FIGS. 9A and 9B include respective schematic diagrams illustrating embodiments of unmanaged solid-state memory elements. FIG. 9A includes an embodiment of an environment or arrangement 900a that includes a host controller 910 communicatively coupled via an interface 911 to a flash memory element 252a arranged with a raw flash store 918a. The host controller 910 includes error correcting code 912, a translation layer 914, a resource identifier store 227 and modified read request logic 229. Although these elements or modules are illustrated as being in the host controller 910, one or more of these elements may be stored in storage devices or registers accessible to the host controller 910 via the bus 221.

The error correcting code 912 is arranged to detect and correct bit errors that may occur in the raw flash store 918a. The translation layer 914 exposes the physical locations in the raw flash store 918a as logical blocks to processing resources in a computing device. The translation layer 914 further includes code that manages unexpected system resets and wear or usage of the flash memory 252a by distributing use of flash blocks evenly. The host controller 910 is further arranged with a resource identifier store 227 and modified read request logic 229. The resource identifier store 227 includes one or more registers that include unique identifiers 916 for each of the non-boot processing resources on a computing device in communication with the host controller 910. The modified read request logic 229 receives a read request for a logical block or file from a processing resource in the computer and when the requesting resource is a non-boot processor generates a modified block read request or command 913 that is forwarded over interface 911 to the flash memory 252a. The modified block read request 913 correctly identifies the physical locations of the requested information (code, file, configuration data, etc.) stored in the non-boot processor store 255 associated with the identified non-boot processor as communicated in an unmodified read request received by the host controller 910 on connection 221.

FIG. 9B includes an embodiment of an environment or arrangement 900b that includes a host controller 920 communicatively coupled via an interface 921 to an error free flash memory 252b. The host controller 920 includes a translation layer 924 that exposes the physical locations in the raw flash store 918b as logical blocks to processing resources in a computing device. The translation layer 924 further includes code that manages unexpected system resets and manages wear or usage of the raw flash store 918b by distributing use of flash blocks evenly. The host controller 920 is further arranged with a resource identifier store 227 and modified read request logic 229. The resource identifier store 227 includes one or more registers that include unique identifiers 916 for each of the non-boot processing resources on a computing device in communication with the host controller 920. The modified read request logic 229 receives a read request for a logical block or file from a processing resource in the computer and when the requesting resource is a non-boot processor generates a modified block read request or command 923 that is forwarded over interface 921 to the flash memory 252b. The modified block read request 923 correctly identifies the physical locations of the requested information (code or data) stored in the non-boot processor store 255 associated with the identified non-boot processor as communicated in an unmodified read request received by the host controller 920 on connection 221. Although these elements or modules are illustrated as being in the host controller 920, one or more of these elements may be stored in storage devices or registers accessible to the host controller 920 via the bus 221.

As further illustrated in FIG. 9B, the error free flash memory 252b is arranged with error correcting code 922. The error correcting code 922 is arranged to detect and correct bit errors that may occur with the raw memory.

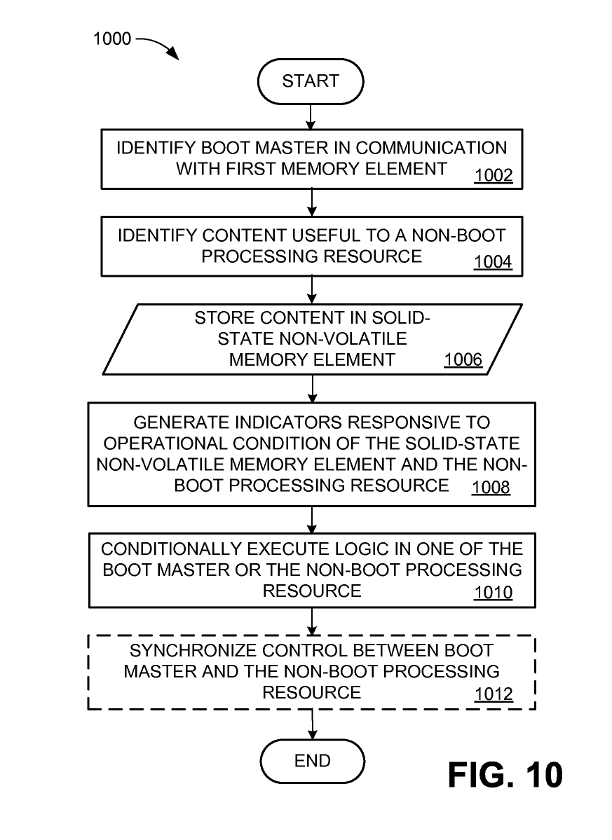

FIG. 10 is a flowchart illustrating an example embodiment of a method 1000 for exposing information stored in solid-state non-volatile memory element 252 to multiple masters in portable computing device 100. The method 1000 begins with block 1002 where a boot master, such as APS 110 in communication with a first memory element 230 is identified. In block 1004 content useful to a non-boot processing resource such as code and static data is identified. Once identified, the content is stored in the solid-state non-volatile memory element 252 as indicated in I/O block 1006. In block 1008, the PCD 100 generates indicators. A first indicator is responsive to an operational condition of the solid-state non-volatile memory element 252. As described, the first indicator is a busy flag, which is set when the solid-state non-volatile memory element 252 is in use. A second indicator is responsive to an operational condition of the at least one non-boot processing resource in the PCD 100. As also described, the second indicator is a wait flag, which is set when the non-boot processing resource is requesting read access to the solid-state non-volatile memory element 252. As shown in block 1010, the PCD 100 conditionally executes logic in one of the boot master or logic in one of the non-boot processing resources. Optionally, as indicated by way of broken line in block 1012, the method 1100 synchronizes control between the boot master and the non-processing resource. As described in association with the example embodiments illustrated in FIG. 2 and FIG. 6, the boot master includes boot master sync logic 500, which was described in association with the flow diagram in FIG. 5.

Certain steps in the processes or process flows described in this specification naturally precede others for the computing device to function as described. However, the computing device and described methods are not limited to the order of the steps described if such order or sequence does not alter the described functionality. That is, it is recognized that some steps may performed before, after, or in parallel (substantially simultaneously) with other steps without departing from the scope of the claimed computing device and methods. In some instances, certain steps may be omitted or not performed. Further, words such as “thereafter”, “then”, “next”, “subsequently”, etc. are not intended to limit the order of the steps. These words are simply used to guide the reader through the description of the exemplary method.

Additionally, one of ordinary skill in power management within a portable, desktop, or server computing device is able to identify appropriate hardware and/or circuits and/or identify appropriate logic and determinations to implement the disclosed embodiments without difficulty based on the flow charts and associated description in this specification. Therefore, disclosure of a particular set of program code instructions, decision thresholds or detailed hardware devices is not considered necessary for an adequate understanding of how to make and use the disclosed computing devices and operating methods. The inventive functionality and aspects of the claimed processor-enabled processes and circuit architectures are explained in more detail in the above description and in conjunction with the drawings, which may illustrate various process flows.

In one or more exemplary aspects as indicated above, the functions described may be implemented in hardware, software, firmware, or any combination thereof. If implemented in software, the functions may be stored as one or more instructions or code on a computer-readable medium, such as a non-transitory processor-readable medium. Computer-readable media include data storage media.

A storage media may be any available media that may be accessed by a computer or a processor. By way of example, and not limitation, such computer-readable media may comprise RAM, magnetoresistive RAM (MRAM), ROM, EEPROM, NAND Flash, NOR Flash, spin-torque MRAM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of non-transitory computer-readable media.

Although selected aspects have been illustrated and described in detail, it will be understood that various substitutions and alterations may be made herein without departing from the present systems and methods, as defined by the following claims.

What is claimed is:

1. A method for exposing a solid-state non-volatile memory element to multiple masters in a computing device, the method comprising:
identifying a boot master in communication with a first memory element;
identifying content useful to a non-boot processing resource;
storing the content useful to the non-boot processing resource in a solid-state non-volatile memory element coupled to the computing device;
generating a set of indicators responsive to a first operational condition of the solid-state non-volatile memory element and further responsive to a second operational condition of the non-boot processing resource; and
conditionally executing logic with the non-boot processing resource to expose the content useful to the non-boot processing resource or executing logic with the boot master to expose content other than the content useful to the non-boot processing resource from the solid-state non-volatile memory element.

2. The method of claim 1, further comprising:
providing an identified set of physical locations in the solid-state non-volatile memory element dedicated to the non-boot processing resource; and
modifying the solid-state non-volatile memory element to process a modified read request that will access the content useful to the non-boot processing resource within the identified set of physical locations.

3. The method of claim 2, further comprising:
providing a register in communication with a host controller, the register available to record an identifier associated with the non-boot processing resource.

4. The method of claim 3, further comprising:
for read requests of the solid-state non-volatile memory element, comparing the identifier with the content in the register; and
upon a match, converting a block read request to the modified read request.

5. The method of claim 1, further comprising:
synchronizing access requests from the boot master and the non-boot processing resource using the set of indicators.

6. The method of claim 5, wherein the set of indicators includes a busy flag that is set when the solid-state non-volatile memory element is being accessed by one of the boot master and the non-boot processing resource.

7. The method of claim 5, wherein the set of indicators includes a wait flag that is set when the non-boot processing resource has issued a request to read the solid-state non-volatile memory element.

8. The method of claim 7, wherein when the wait flag is set the boot master will cease using the solid-state non-volatile memory element.

9. The method of claim 8, further comprising:
removing power from the boot master.

10. The method of claim 1, wherein using the boot master to generate the set of indicators in the first memory element includes allocating a busy flag and a wait flag.

11. The method of claim 10, wherein a busy flag set condition indicates that the solid-state non-volatile memory element is presently being accessed by one of the boot master or the non-boot processing resource.

12. The method of claim 10, wherein a busy flag not set condition indicates that the solid-state non-volatile memory element is not presently being accessed by one of the boot master or the non-boot processing resource.

13. The method of claim 10, wherein a wait flag set condition indicates that the non-boot processing resource is waiting for the boot master to complete a presently active access of the solid-state non-volatile memory element.

14. The method of claim 13, wherein when the computing device includes two or more non-boot processing resources the wait flag is associated with an identifier that includes a representation of a unique non-boot processing resource.

15. The method of claim 1, wherein identifying the boot master includes identifying an application processing sub-system that loads an operating system and defines a file system.

16. The method of claim 15, further comprising:
using the boot master to open a file for the non-boot processing resource;
receiving with the boot master information that identifies a physical location of the content useful to the non-boot processing resource in the solid-state non-volatile memory element; and
storing in the first memory element a physical address map that identifies the physical location of the content useful to the non-boot processing resource.

17. The method of claim 16, wherein when the non-boot processing resource requests access to the solid-state non-volatile memory element, such request is served by sending the physical location in the first memory element to a host controller coupled to the solid-state non-volatile memory element.

18. The method of claim 17, further comprising:
removing power from the boot master.

19. A computing device, comprising:
a system-on-chip including a boot master and a non-boot processing resource;
an interface bus in communication with the boot master and the non-boot processing resource;
a memory controller coupled to the interface bus and to a random access memory element, wherein the boot master is configured to allocate storage in the random access memory element for a set of indicators; and
a host controller coupled to the interface bus and to a solid-state non-volatile memory element, the solid-state non-volatile memory element having stored therein code and data dedicated for execution and use by the non-boot processing resource, the set of indicators responsive to a first operational condition of the solid-state non-volatile memory element as identified by the host controller and further responsive to a second operational condition of the non-boot processing resource,
wherein the system on chip conditionally executes logic with the non-boot processing resource to expose the code and data dedicated for execution and use by the non-boot processing resource or executes logic with the boot master to expose content other than the code and data dedicated for execution and use by the non-boot processing resource from the solid-state non-volatile memory element.

20. The computing device of claim 19, wherein the random access memory element includes a physical address map that identifies a physical location of the code and data dedicated for execution and use by the non-boot processing resource.

21. The computing device of claim 20, wherein the physical address map includes an association of logical addresses and physical locations.

22. The computing device of claim 21, wherein for the non-boot processing resource requesting access to the solid-state non-volatile memory element, such access is served by sending the physical locations in the random access memory element to the host controller.

23. A computing device, comprising:
means for controlling data transfers to and read access from a solid-state non-volatile memory element, the means for controlling responsive to one of a boot master and at least one non-boot processing resource;
means for segregating a portion of a solid-state non-volatile memory element, the portion including code and data for use by the at least one non-boot processing resource;
means for monitoring when the solid-state non-volatile memory element is in use; and
means for monitoring an operational condition of the at least one non-boot processing resource;
wherein the computing device conditionally executes logic with the at least one non-boot processing resource to expose the code and data dedicated for execution and use by the at least one non-boot processing resource or executes logic with the boot master to expose content other than the code and data for use by the at least one non-boot processing resource from the solid-state non-volatile memory element.

24. The computing device of claim 23, wherein an association of information that identifies the physical location of the code and data dedicated for use by the at least one non-boot processing resource is performed.

25. The computing device of claim 24, wherein the association of information that identifies the physical location of the code and data dedicated for use by the at least one non-boot processing resource is stored in a physical address map of logical addresses and physical locations.

26. The computing device of claim 25, wherein for a non-boot processing resource requesting access to the solid-state non-volatile memory element, such access is served by sending the physical locations in a random access memory element to the means for controlling.

27. The computing device of claim 25, wherein for a non-boot processing resource requesting access to the solid-state non-volatile memory element, such access is managed by a memory controller responsive to a resource identifier.

28. The computing device of claim 25, wherein for read requests of the solid-state non-volatile memory element, the means for controlling data transfers to and read access from a solid-state non-volatile memory element compares a request identifier received via a bus with information in a register.

29. The computing device of claim 28, wherein upon a match of the request identifier and information in the register, the means for controlling data transfers to and read access from a solid-state non-volatile memory element converts a block read request to a modified read request.

30. The computing device of claim 28, wherein power supplied to the boot master is reduced while the non-boot processing resource accesses the code and data.
